(19) United States
(12) Patent Application Publication
(10) Pub. No.: US 2024/0273619 A1
(43) Pub. Date: Aug. 15, 2024

(54) INTEREST BOARD FOR A SAVINGS OR CREDIT ACCOUNT

(71) Applicant: Wells Fargo Bank, N.A., San Francisco, CA (US)

(72) Inventors: Jason V. Biala, Martinez, CA (US); Miriam Felecia Clark, San Francisco, CA (US); Ryan Lee Hammond, San Jose, CA (US); Margaret Seter Honeycutt, Crockett, CA (US); Jason Huang, San Francisco, CA (US); Julio Jiron, San Bruno, CA (US); Dennis E. Montenegro, Concord, CA (US); Sadie S. Salim, Mill Valley, CA (US); Christopher Sipanya, San Jose, CA (US); Sergey Yamandiy, Castro Valley, CA (US); Wyman Yu, San Francisco, CA (US); Konstantin N. Zheludkov, Pacheco, CA (US)

(21) Appl. No.: 17/661,166

(22) Filed: Apr. 28, 2022

(51) Int. Cl. G06Q 40/02; G06Q 20/10

(52) U.S. Cl. CPC G06Q 40/02; G06Q 20/108

(57) ABSTRACT

Systems and methods may generally be used to link two or more accounts. An example method may include creating a first savings account for a first user for a particular purchase and linking the first savings account to a second savings account of a second user for the particular purchase. The method may include receiving a goal for one of the first or second savings accounts. A suggested action for the first user may be determined using a trained model based on the particular purchase, the goal, and the first and second savings accounts. The suggested action may be output for display, such as on a user interface.

### BACKGROUND

Savings accounts are used to accumulate money safely at a financial institution. Some savings accounts include an interest rate. A user may have other types of accounts at the financial institution, such as a retirement account, a checking account, etc. Modern banking conveniences allow users to access information related to a savings account from almost anywhere, for example via an app on a mobile device, a website, or at a financial institution location.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system for providing an account according to an interest in accordance with some embodiments.

FIGS. 2A-2C illustrate user interfaces for displaying various aspects of an interest list or an account in accordance with some embodiments.

FIG. 3 illustrates a flowchart showing a technique for linking two or more accounts in accordance with some embodiments.

FIG. 4 illustrates a block diagram showing process flows in accordance with some embodiments.

FIG. 5 illustrates a flowchart showing a technique for providing a predicted feasible purchasing option for a future purchase using a model in accordance with some embodiments.

FIG. 6 illustrates generally an example of a block diagram of a machine upon which any one or more of the techniques discussed herein may perform in accordance with some embodiments.

### DETAILED DESCRIPTION

The systems and techniques described herein provide a goal or interest oriented savings account. The savings account may be tied to a particular goal or interest, such as a trip, a large purchase, a savings amount, a charitable contribution amount, or the like. The savings account may be a new savings account or a sub-savings account of another account of a user (e.g., a user's main savings account, checking account, credit line, mortgage, etc.). The savings account may be linked to another savings account (e.g., of another user, for example another user also saving towards the goal, either separately or as a combined effort), linked to a social media account (e.g., to identify interests), linked to a separate reward model (e.g., for a parent to reward a child for saving a threshold amount), or the like.

The systems and techniques described herein provide options for ranking interests, for example for purchase via a specified savings account. The interests may be provided by a user or generated automatically for the user. The interests may correspond to social media activity in some examples. The interests may be ranked according to user input or based on user activity (e.g., when friends discuss a trip on social media or via a communication stream, the trip may be elevated in the rankings).

A model may be used to provide a suggested action for a user with a specific savings account. The suggested action may be a feasible purchasing option (e.g., a timeline for purchasing an item, a savings amount plan for purchasing two or more items, etc.), a suggestion to the user to contribute an amount of money to the specific savings account or to another user's savings account, a suggestion to request a donation, a suggestion to donate, a suggestion to pool money in two or more savings accounts, a suggestion to make a purchase, or the like. In some examples, when a goal has been reached, a purchase may be made automatically or a predetermined amount of money may be moved automatically (e.g., to another savings account).

The present systems and techniques may use specific savings accounts, which may be linked, of two or more users. The two or more users may be connected on a social media network or via a communication stream (e.g., text message, email, etc.). Linking savings accounts of the two or more users may include asking the first and second users to confirm sharing information about the first and second savings accounts based on the social media network connection. In other examples, three or more savings accounts may be linked. When linking savings accounts, users of each of the respective savings accounts may be granted access to view the savings accounts (e.g., total amount only, or total amount with deposits or withdrawals or both), while not being allowed to withdraw any money from the other user's savings account. In some examples, a user may deposit into but not withdrawal from another user's savings account.

In some examples, a user may have two or more savings accounts for various interest or goals. For example, a user may have two savings accounts, each corresponding to a respective purchase goal. The user may indicate (e.g., on social media, or to the institution hosting the savings accounts) that the user is looking for other users interested in one or more of the purchase goals. The user's savings account may be automatically linked (e.g., after the user grants permission) to another user's savings account when the particular purchase selected by the user corresponds to a purchase of a second user's savings account.

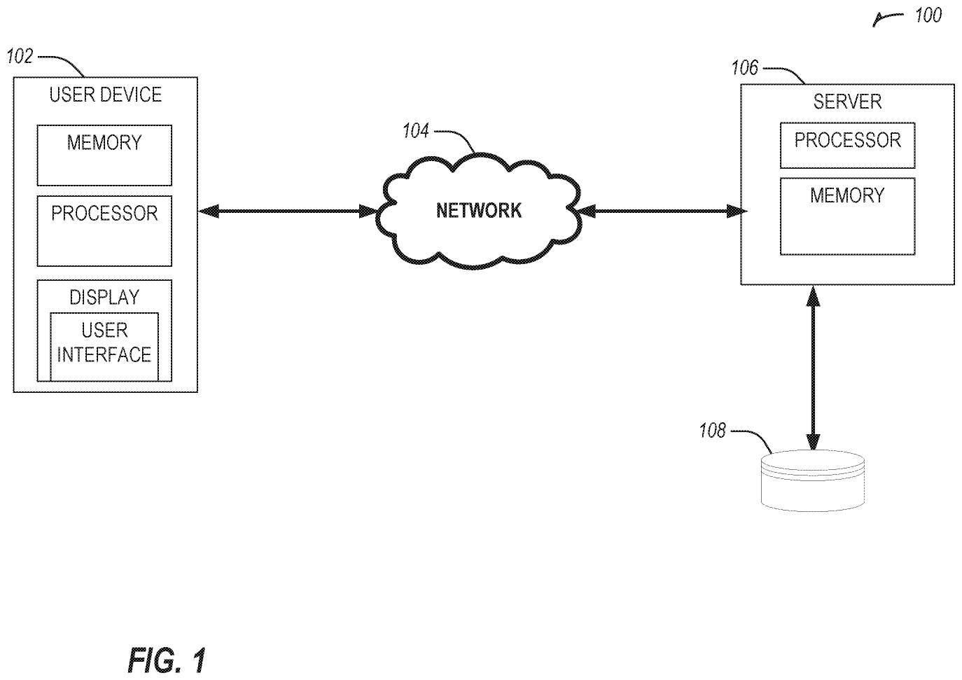

FIG. 1 illustrates a system 100 for providing an account according to an interest in accordance with some embodiments. The system 100 includes a user device 102 having memory and a processor. The user device 102 may include a display for showing a user interface. The user device 102 may communicate (e.g., via a network 104, such as the internet) with a server 106, the server 160 having memory and a processor. The server 106 may include or be in communication with a database 108. The database 108 may store information, such as a user interest board, savings account data, or other data as discussed herein.

The user device 102 may display, on the user interface, a website or other interface for selecting an interest or a savings account (e.g., corresponding to an interest). An interest board may include information to help a user make a decision (e.g., a financial decision, an election, a big purchase such as a house, car, etc. what school to attend, whether to buy or rent, a career, a hobby, a side hustle, or the like). The interest board may be associated with a financial account, financial app, financial service, financial entity (e.g., a bank), or the like. The interest board may include a collection of interests in an interest board format, where a user may see shared interests (e.g., of other users), add interests (e.g., searched, shared, created, etc.) to their board. This integration allows for linking to an application or an API to help a user decide whether to make a purchase, when to make a purchase (e.g., based on spending habits, cost of the purchase, etc.), or tools to provide social network interactivity regarding a purchase.

A user may have a board is displayable (e.g., on the display of the user device 102) that is used when a user wants to make a big purchase for example. The board may be used to collate research on a purchase and to link to a budgeting or goal application, for example. The board may also provide links to help with a purchase or find more information on an item. The board may be stored in the database 108, and accessed over the network 104 by the user device 102 in communication with the server 106.

The board may be used for research at a convenient time for a user (e.g., on the user device 102, which may include a mobile phone, a tablet, a computer, etc.) such as during a commute, lunch, after work, in the evenings, etc. The board may be used to staging a big purchase over time, such as by tying a big purchase to a savings account. The savings account may include features to help with the big purchase or other interest on the board. The savings account features may include limiting withdrawals (e.g., only one a month, only when a threshold amount is reached, etc.), requiring withdrawals at a particular time (e.g., a time of day, such as morning, when users are likely to be more objective and less impulsive), linking to another savings or a checking account for transfers into the savings account, requiring a cool-down period (e.g., request to withdraw funds is granted on a delay, such as X hours for purchases above $Y), or the like.

The savings account and interest board may be used to help a user plan for a purchase by displaying budget considerations (e.g., income, bills, savings, how long the saving for the purchase will take, etc.). The user interface may display an interest or to be made purchase on the board, such as an item identified by a user. The board may include a lower or higher cost alternative to the item. The board may present additional information related to the item, such as a seller's return policy, shipping costs, etc.

The board may include an automatic tag for an item or purchase, such as a budget categorization (e.g., home, travel, work, etc.). In some examples, additional information related to an interest may be displayed or linked to, such as information related to purchasing a house, including a loan officer, financing, mortgage, simulated effect on credit score of a purchase, or other information. Different information may be displayed for large purchases (e.g., house or car) than moderate purchases (e.g., ice cream maker, moped, etc.). The board may include a variable time frame based on purchase cost, savings amount, savings projection, income, etc. The projection may include how much money will be needed for a purchase or for multiple purchases. Based on the projection, information may be presented including a recommendation for how to save for the purchase, how the purchase will affect finances of the user, or the like.

The user device 102 may be used to add, update, or rank interests. For example, a user's desire for a product may change over time. The user may select a desirability ranking (e.g., “On a scale of 1-10, how much do you want this today?”), and desire may be tracked over time. Other rankings may include ranking more than one purchase. A user may rank multiple purchases. In some examples, purchases on a board may be ranked automatically, such as according to a purchase timeline. In either for these examples, an indication may be presented on the user interface, such as “if you buy A, it will take you X weeks to buy B. In some examples, a suggested purchase order or combination may be presented to a user (e.g., for two or more interests out of a set of interests on the board). The rankings may be generated in some examples based on a time decay, for example if an interest has not been updated or added after some number of days, weeks, or months, the interest may be lowered on the ranking. In some examples, other users may share their purchases, interests, boards, savings account values, or decision processes.

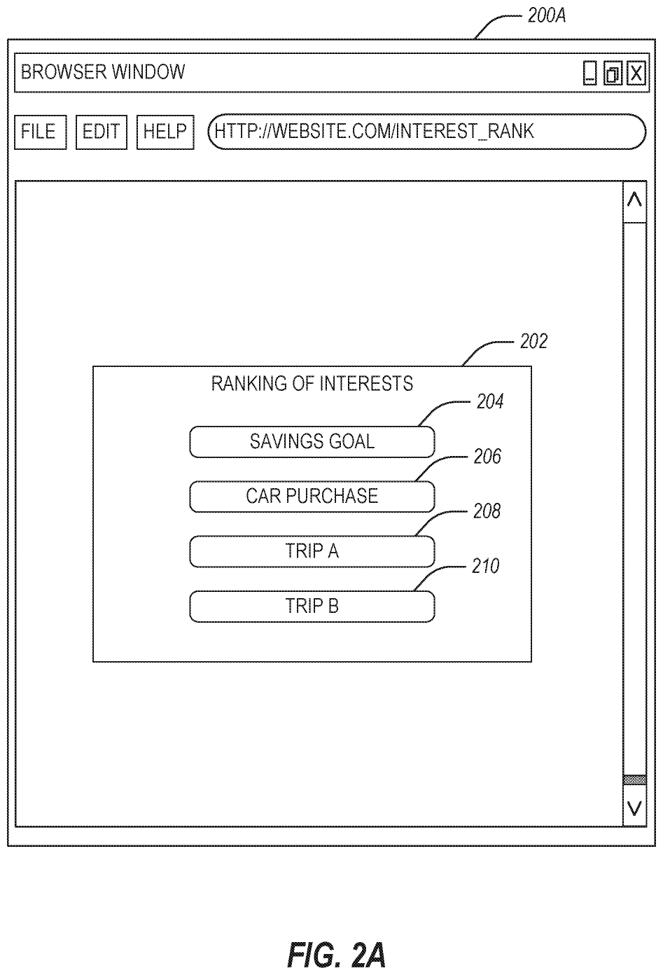

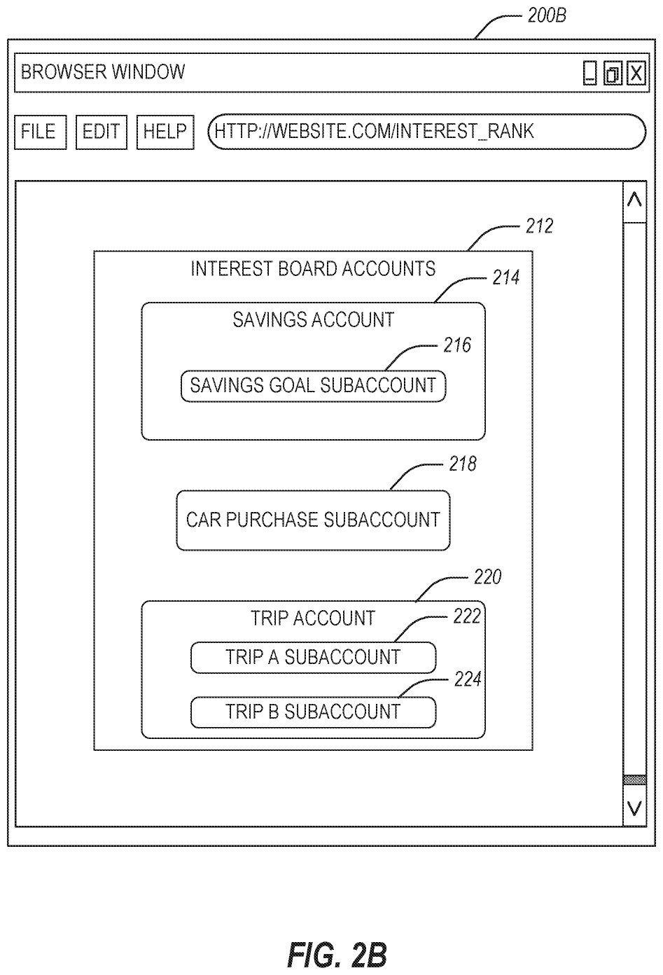

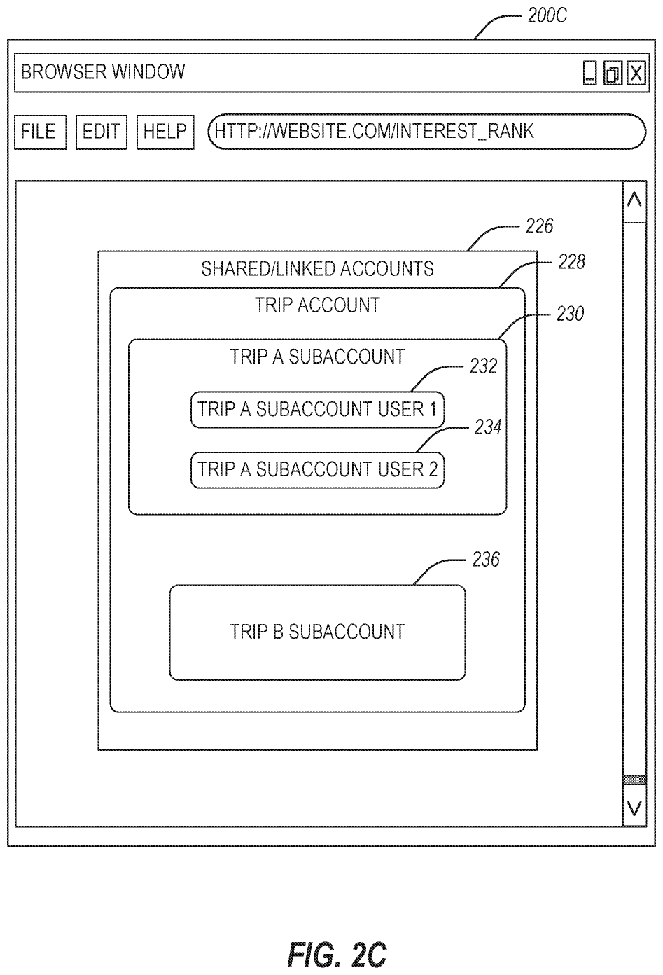

FIGS. 2A-2C illustrate user interfaces for displaying various aspects of an interest list or an account in accordance with some embodiments.

FIG. 2A includes a user interface 200A showing a ranking of interests. The ranking may be based on various factors, which may be user-specific, interest-specific (e.g., interest type, such as travel, home, car, purchase or not purchase, etc.), or time-dependent. The example ranking shown in a board 202 on the user interface 200A includes interests such as a savings goal 204, a car purchase 206, and two trips, trip A 208 and trip B 210. The listing of interests on the board 202 may not necessarily be ranked, although shown in an order in the user interface 200A.

The ranking in the board 202 of the interests may be based on user desirability of each of the interests (e.g., the user of the board 202 desires the savings goal 204 to be met more than the other interests, and favors trip A 208 over trip B 210. In some examples, the ranking may be based on feasibility (e.g., within a given time frame, which is the cheapest, which order will result in total overall lowest cost, such as for the trips, etc.), where the interests may be accomplished sequentially. In some examples, the ranking may be based on savings projections (e.g., based on income, bills, cost of the interest, etc.). The ranking may be based on a combination of factors, such as with median, average, or weighting of interests or rankings. The ranking of interests in the board 202 may be displayed according to interactions from the user in each of the interests as tracked over time.

The rankings on the board 202 may be used to compare interests of a particular type. For example, for a user interested in purchasing a vacation home, the board 202 may display a rank of vacation homes in a particular area based on available savings, projected savings, and costs of the vacation homes. In an example, potential issues may be used in the ranking, such as number of emergencies or crime rate in the area, mortgage issues unique to a county or state, or the like. In some examples, publicly accessible data may be used to change the ranking, such as proximity of homes to a beach or skiing, for example. In some examples, the ranking may be based on interaction with social media or other boards (e.g., for a user interested in skiing with shares or likes on social media for skiing or ski boots in an interest board, a vacation home may be suggested where skiing is readily available or accessible).

When a user selects one of the items of interest in the board 202, additional details related to the interest may be displayed. For example, if a user selects the car purchase 206 indication, a link to credit options, a predicted effect on credit score, a savings gap, or the like may be displayed. In some examples, information may be displayed or used in ranking according to a user's social preferences (e.g., green energy, sustainability, vegan food, etc.).

FIG. 2B includes a user interface 200B showing an account according to an interest. The user interface 200B illustrates an example set of accounts related to an interest board. The user interface 200B includes an account user interface component 212 that displays the accounts related to the interest board. The accounts in the account user interface component 212 may be subaccounts of a main savings or checking account, or may be separate. In an example, the accounts may not be actually subaccounts, but instead may be virtual subaccounts. In this example the accounts are displayed as separate accounts but are actually held in a single savings account (e.g., for banking or accounting purposes).

The account user interface component 212 includes examples of dedicated savings accounts, such as a general interest board savings account 214, which may be used, for example, for any interest purchases (or otherwise). The general interest board savings account 214 is shown with a savings goal subaccount 216. The savings goal subaccount 216 may be used to reach a savings goal, for example according to an entry on the interest board. The savings goal subaccount 216 may include an automatic transfer feature. For example, an automatic transfer may occur from the general interest board savings account 214 when that account has over a threshold amount of money, or on a particular date. In another example, an automatic transfer from the savings goal subaccount 216 may occur when the savings goal is reached (e.g., to a long term savings account, to another financial instrument such as a certificate of deposit, bonds, stocks, mutual funds, exchange traded funds, cryptocurrency, etc.).

The account user interface component 212 includes a car purchase account 218, which may be used to accumulate savings for the purpose of fulfilling a car purchase goal from the interest board. The account user interface component 212 includes a trip account 220, which may be used for saving for trips in general. The trip account 220 includes two subaccounts, a trip A subaccount 222 and a trip B subaccount 224. In some examples, the specific trip subaccounts may be generated when a user has a specific plan for a trip (e.g., save up to go to a friend's destination wedding), while the trip account 220 may be used to save up for trips in general.

In an example, a recommendation may be provided on the user interface 200B related to one of the accounts. For example, a recommendation may be provided to consider making a purchase when an account reaches a threshold (e.g., a user selected amount of money in the account). In some examples, money may be automatically accrued to an account, such as when a user receives a paycheck. The money may be allocated among the various accounts according to a user defined set of rules, such as based on percentages, or otherwise. For example, the user may select to put the first $X into the savings account 214, the next $Y into the savings goal subaccount 216, the next SZ into the car purchase account 218, and so on. In this example, sometimes an account may not be funded. In an example, instead of user defined rules, the money may be allocated (whether by dollar or percentage) according to a ranking on the interest board (e.g., the board 202 of FIG. 2A).

In some examples, money may be allocated to one or more of the accounts in the account user interface component 212 automatically. For example, a user may select a roundup rule (e.g., round up purchases to the nearest dollar or ten dollars and allocate the overage to the accounts), select a healthy or frugal habit rule (e.g., when a purchase is made from a particular store, such as a healthy food store or a less expensive store or product, add a set amount of money to the accounts). In an example, when a user purchases a cheaper version of a product, the amount of money saved (over the more expensive version or the most expensive version, which may be determined automatically by a server) may be deposited or distributed into the accounts.

Other examples of specific savings accounts may include one for saving money to send to family (e.g., via a Global Remittance to a foreign country), savings for education (e.g., for a child's college fund), or a retirement savings account. In some examples, a reminder may be sent to a user of their interest board, such as when their paycheck comes in (e.g., a push notification), which may recommend that the user set aside some money from the paycheck for the interest board or set up a recurring savings plan.

In an example, a suggestion may be provided to a user for how to purchase two or more items from their interest board. For example, the suggestion may include moving money from the savings account 214 to one of the subaccounts (e.g., to the car purchase subaccount 218). The suggestion may indicate that two purchases may be made within a timeframe, such as trip B and a car, and may optionally indicate that trip A and the car are not feasible within the timeframe. The suggestion may include advising the user to save more money for a period of time to catch up on a goal timeline for purchasing a product. When the suggestion relates to making two or more purchases, the suggestion may be based on cost of the purchases, which may change over time. For example, it may be advantageous to book a flight before purchasing a car, when the flight is further away and potentially cheaper, while the car is likely to remain at the same price over the timeframe.

FIG. 2C includes a user interface 200C showing linked accounts. The user interface 200C includes a shared or linked accounts user interface component 226. The component 226 displays accounts from a first user's perspective. The component 226 includes a trip account 228, which may operate similarly to the trip account 220 of FIG. 2B, a trip A subaccount 230 (e.g., similar to trip A subaccount 222 of FIG. 2B), and a trip B subaccount 236, which may be similar to trip B subaccount 224 of FIG. 2B. The trip A subaccount 230 may be displayed with further subaccounts including a first user's trip A subaccount 232 and a second user's trip A subaccount 234. For example, when two users want to take a trip together, they may save money in savings accounts or a savings account (e.g., displayed with subaccount granularity). The trip A subaccount 230 may display a total amount of money available in each of the subaccounts 232 and 234, in some examples.

The subaccounts 232 and 234 may be viewable only to non-custodial users, or in some examples, a non-custodial user may be able to deposit or withdraw money from another user's account (e.g., in certain circumstances). In some examples, the non-custodial user may be limited to deposits only in the other account. Linking or sharing the subaccounts 232 and 234 may include a user providing permission to another user to link or share a subaccount. The permission may include viewing rights, withdrawal rights, deposit rights, etc., and the rights may be subject to limitation (e.g., a time limit such as not to exceed the date of purchase or travel, an amount limit such as for withdrawal, or the like).

A threshold may be generated for a subaccount, such as subaccount 230, 232, or 234. In some examples, the thresholds may be related. For example, each of the subaccounts 232 and 234 may have a minimum threshold for triggering a suggestion to take the trip (or an automatic purchase), and those minimum thresholds may be equal or different. The subaccount 230 may have a minimum threshold, which may be based on total deposits available in both of the subaccounts 232 and 234.

The shared or linked subaccounts 232 and 234 may be used to plan for a trip A. Each user may contribute to their own subaccount, or each other's subaccount. In some examples, more than the two users subaccounts shown may be added for sharing or linking. When linking or sharing more than two subaccounts, permissions may vary among the different combinations of users and subaccounts. In an example, the user interface 200C may include a communication component, for example to allow the first user and the second user to communicate about the trip A. In some examples, a suggested action may be displayed to a user. For example, a suggested action may include a suggestion to the first user to contribute an amount of money to the subaccount 232 that matches a deficit between the subaccount 232 and the subaccount 234. In another example, a suggested action may include a suggestion to the first user to request a donation from the second user based on a deficit between the subaccount 232 and the subaccount 234. A suggested action may include a suggestion to the first user to donate money to the subaccount 234 based on a deficit between the subaccount 232 and the subaccount 234. In an example, the suggested action may include a suggestion to pool the subaccounts 232 and 234 (e.g., in subaccount 230) based on a determination that a goal has been reached. A suggestion may include to book the trip, for example when a threshold is met (for one or all accounts).

While the example in FIG. 2C is illustrated with a trip example, other interests may be used in similar ways. For example, an interest may include a charity or a “cause” where donations may be sought from friends or family, for example for a birthday or holidays. In some examples, sharing an account may be one-way. For example, a teenager who wants to build a dream gaming computer may share an account with a parent or guardian of a teenager. The parent or guardian account may be set up to give (automatically or manually) money to the teenager's account when the teenager achieves some sort of goal, such as buying healthy food, working out, cleaning a room, getting good grades, etc. The teenager may not be able to see or access the parent or guardian account, but the parent or guardian may be able to see the teenager's account (which may be a subaccount of the parent or guardian account in some examples).

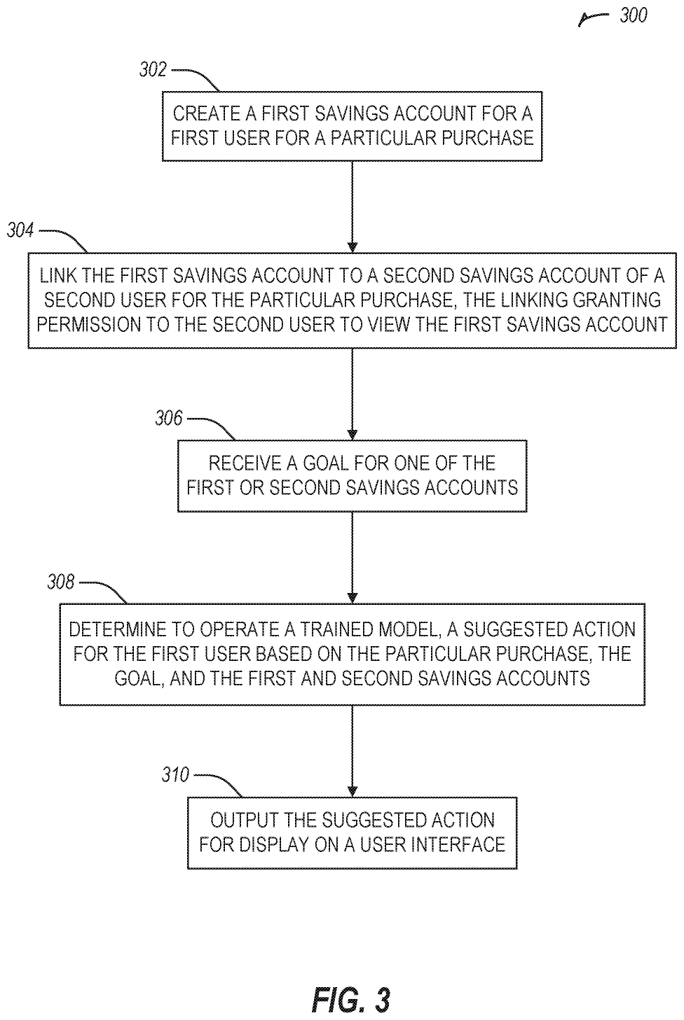

FIG. 3 illustrates a flowchart showing a technique 300 for linking two or more accounts in accordance with some embodiments. In an example, operations of the technique 300 may be performed by processing circuitry, for example by executing instructions stored in memory. The processing circuitry may include a processor, a system on a chip, or other circuitry (e.g., wiring). For example, technique 300 may be performed by processing circuitry of a device (or one or more hardware or software components thereof), such as those illustrated and described with reference to FIG. 1.

The technique 300 includes an operation 302 to create a first savings account for a first user for a particular purchase. The first savings account may be a sub-account of a main savings account of the first user (or of a savings account of another user, such as a parent or guardian). The sub-account may be created virtually (e.g., managed via a bank, such as with an app or on a website), without needing a full formal new account.

The technique 300 includes an operation 304 to link the first savings account to a second savings account of a second user for the particular purchase, the linking granting permission to the second user to view the first savings account. Linking the first and second savings accounts may include linking the first and second savings accounts to a third savings account of a third user, the linking granting permission to the first, second, and third users to view the first, second, and third savings accounts. In an example, the second user has a plurality of savings accounts, each corresponding to a respective purchase or goal. In this example, the plurality of savings accounts may include the second savings account. Operation 304, in this example, may include linking the first savings account to the second savings account based on identifying that the particular purchase selected by the first user for the first savings account corresponds to a purchase of the second savings account. The correspondence of the purchases may be for identical or similar purchases or may be for complementary purchases.

The technique 300 includes an operation 306 to receive a goal for one of the first or second savings accounts. The goal may be unique to the first or second savings account (e.g., each account may have a different goal, such as based on unique aspects to the particular purchase for each user, such as flight costs). In another example, the goal may be joint to the first and second savings accounts (e.g., a pooled amount). The goal may be monetary (e.g., reach a particular amount in an account) or non-monetary. Non-monetary examples may include lifestyle achievements such as fitness, eating healthy, reading, spending time with family or friends, etc., work-related goals, such as reaching a particular title, income, etc., or the like.

The technique 300 includes an operation 308 to determine to operate a trained model, a suggested action for the first user based on the particular purchase, the goal, and the first and second savings accounts. The suggested action may include a suggestion to the first user to contribute an amount of money to the first savings account that matches a deficit between the first savings account and the second savings account. The suggested action may include a suggestion to the first user to request a donation from the second user based on a deficit between the first savings account and the second savings account. The suggested action may include a suggestion to the first user to donate money to the second savings account based on a deficit between the first savings account and the second savings account. The suggested action may include a suggestion to pool the first and second savings accounts based on a determination that the goal has been reached. The suggested action may include a suggestion to make the particular purchase based on a determination that the goal has been reached.

The technique 300 includes an operation 310 to output the suggested action for display on a user interface.

The technique 300 may include an operation to determine that the goal has been reached, and in response automatically move a predetermined amount of money from the second savings account to the first savings account.

In an example, the first and second users are connected on a social media network. In this example, linking the first savings account to the second savings account may include asking the first and second users to confirm sharing information about the first and second savings accounts based on the social media network connection.

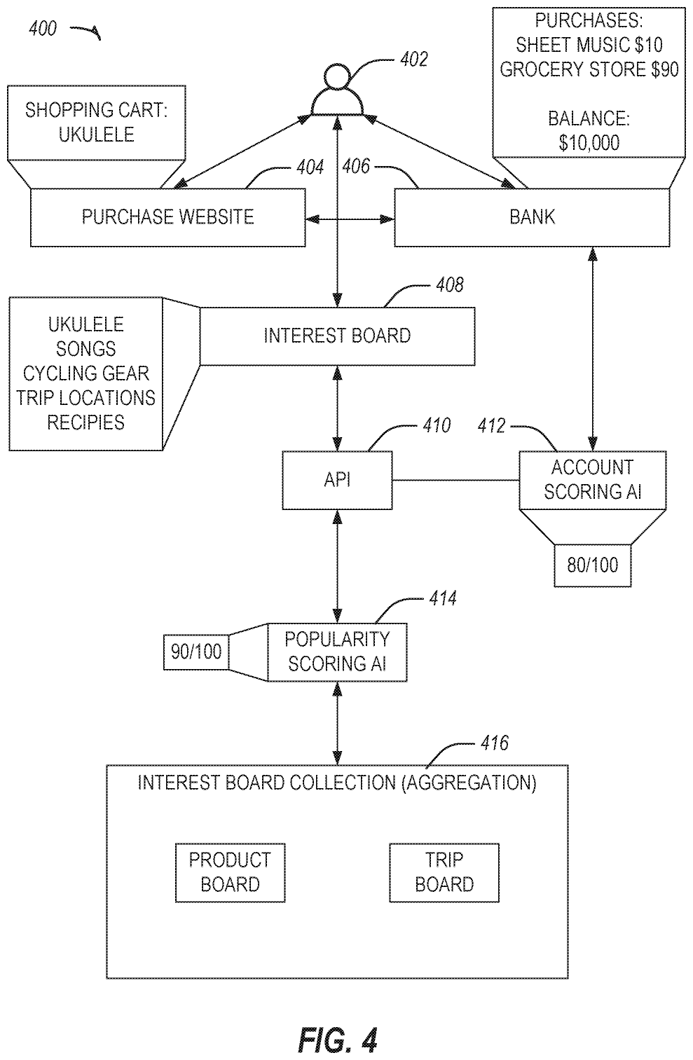

FIG. 4 illustrates a block diagram 400 showing process flows in accordance with some embodiments. The block diagram 400 illustrates communication or information flow between different blocks. A user 402 may interact with a website 404 to make a purchase (e.g., via a shopping cart, for example for a ukulele). The user 402 may interact with a bank 406, such as to maintain an account, pay for purchases, etc. The user 402 may interact with an interest board 408, for example to add or remove interests, rank interests, change interests, etc.

When a user maintains an interest board 408, the interest board 408 information may be provided to the bank 406 (e.g., via an API 410). The information may be used by an account scoring AI 412 (e.g., a machine learning trained model), in some examples, to match interests on the interest board 408 to purchases or a savings account at the bank 406. The API 410 may be accessed in some examples to send information to an interest board collection 416 (e.g., an aggregation of the user's interests or a set of users' interests), which may be filtered via a popularity scoring AI 414 (e.g., a machine learning trained model). The interest board collection 416 may generate a product board and a trip board, for example. These may each be tied back to a savings account at the bank 406. The bank 406 may interact with the website 404 (e.g., retrieve purchase information, receive purchase data, etc.). The bank 406 may use purchase information such as cost to evaluate a savings account of the user 402 based on the interest board 408 or the interest board collection 416. For example, the bank 406 may notify the user 402 that the user 402 has sufficient funds to make a purchase or that the user 402 should save more to buy something from the website 404.

The bank 406 may use historical user data and the interest board 408 or the interest board collection 416 to make a recommendation. For example, historical financial data for the user 402 may show that the user 402 eats out 3 times a week for lunch. When a week is completed where the user 402 only ate out twice or once or none, then the money normally spent on three lunches (minus what was spent) may be placed into a savings account corresponding to a product to be purchased. The interest board collection 416 may include a ranking, such as a popularity score among a set of users.

In some examples, the bank 406 may maintain a controlled environment for user interactions related to savings or planning purchases. Within this controlled environment, a user may share promos or offers where both the sharer and the one sharing receive benefits (e.g., refer a friend), send a payment to another user, share progress towards saving up money for something (e.g., a boat), or accumulating points for a rewards purchase (e.g., a plane fare to Hawaii), organize a fundraiser, organize a group saving effort, such as a fancy dinner or a trip, a monetary gift request or registry, or the like. Users may share feedback on customer service received, or safety of an ATM (e.g., the lights are out, or “is that a skimmer I saw”) for example, so that the bank 406 may take action to remedy the issue. The controlled environment may include general messaging (e.g., for coordination, reminders, encouragement, information, etc.).

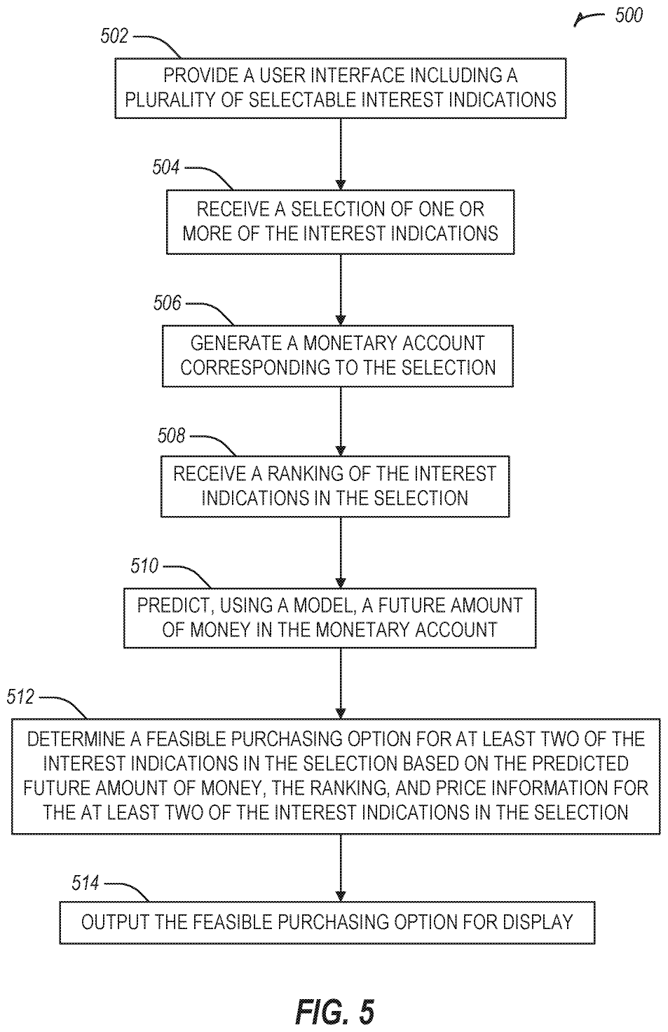

FIG. 5 illustrates a flowchart showing a technique 500 for providing a predicted feasible purchasing option for a future purchase using a model in accordance with some embodiments. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 1.

The technique 500 includes an operation 502 to provide a user interface including a plurality of selectable interest indications. The interest indications may include a product, a goal, a trip, etc. For example, the interest indications may include a goal of saving a particular amount of money, a product such as a car or house, a trip to Europe, etc.

The technique 500 includes an operation 504 to receive a selection of one or more of the interest indications. The technique 500 includes an operation 506 to generate a monetary account corresponding to the selection. The monetary account may be a subaccount of a savings or checking account of a user, or may be a new monetary account.

The technique 500 includes an operation 508 to receive a ranking of the interest indications in the selection. The ranking may be within a category (e.g., product A over product B) or across categories (e.g., trip over savings goal).

The technique 500 includes an operation 510 to predict, using a model, a future amount of money in the monetary account. The prediction may be based on past transactions (e.g., income), likely future income or costs (e.g., supplied by a user), a projection of a retirement or savings account, or the like.

The technique 500 includes an operation 512 to determine a feasible purchasing option for at least two of the interest indications in the selection based on the predicted future amount of money, the ranking, and price information for the at least two of the interest indications in the selection. The feasible purchasing option may be based on prediction of a cost or price for one or more of the at least two of the interest indications. Operation 512 may include providing a plan to purchase a higher ranked interest indication first and a lower ranked interest indication after the higher ranked one.

The technique 500 includes an operation 514 to output the feasible purchasing option for display. The feasible purchasing option may be output for display in an app, via a browser, etc., such as on a screen of a user device.

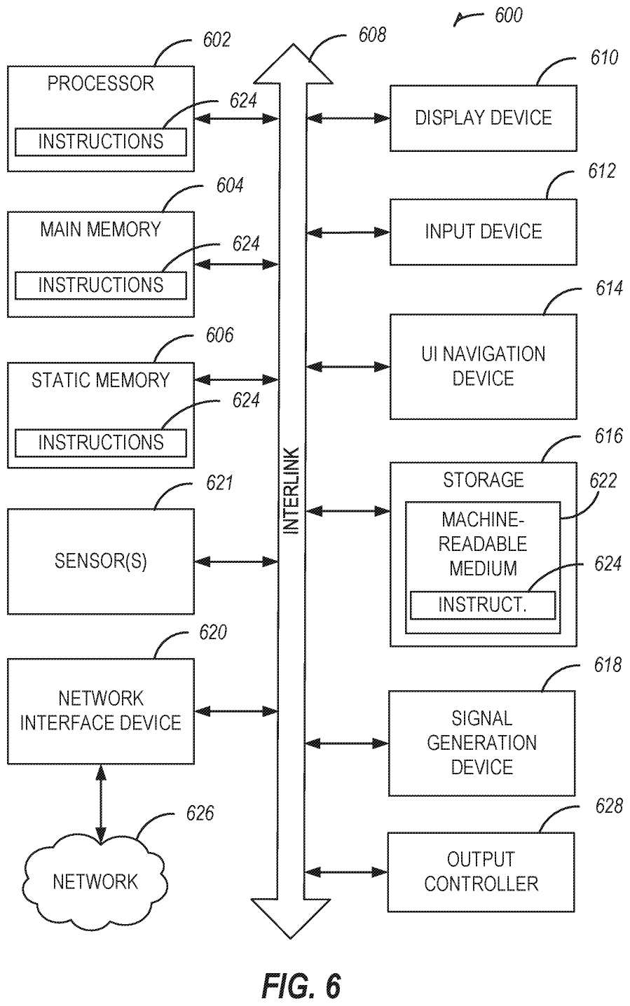

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. In some examples, the machine 600 may be a wearable device. In some examples, the machine 600 may include an augmented reality (AR), virtual reality (VR), or mixed reality (MR) device.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: creating, using a processor, a first savings account for a first user for a particular purchase; linking, using the processor, the first savings account to a second savings account of a second user for the particular purchase, the linking granting permission to the second user to view the first savings account; receiving a goal for one of the first or second savings accounts; determining, using the processor, to operate a trained model, a suggested action for the first user based on the particular purchase, the goal, and the first and second savings accounts; and outputting the suggested action for display on a user interface.

In Example 2, the subject matter of Example 1 includes, wherein the suggested action includes a suggestion to the first user to contribute an amount of money to the first savings account that matches a deficit between the first savings account and the second savings account.

In Example 3, the subject matter of Examples 1-2 includes, wherein the suggested action includes a suggestion to the first user to request a donation from the second user based on a deficit between the first savings account and the second savings account.

In Example 4, the subject matter of Examples 1-3 includes, wherein the suggested action includes a suggestion to the first user to donate money to the second savings account based on a deficit between the first savings account and the second savings account.

In Example 5, the subject matter of Examples 1-4 includes, wherein the suggested action includes a suggestion to pool the first and second savings accounts based on a determination that the goal has been reached.

In Example 6, the subject matter of Examples 1-5 includes, wherein the suggested

action includes a suggestion to make the particular purchase based on a determination that the goal has been reached.

In Example 7, the subject matter of Examples 1-6 includes, wherein the goal is unique to the first savings account and a second goal corresponds to the second savings account, the goal and the second goal including at least one different value.

In Example 8, the subject matter of Examples 1-7 includes, wherein the goal is a joint goal for the first and second savings accounts.

In Example 9, the subject matter of Examples 1-8 includes, wherein the first savings account is a sub-account of a main savings account of the first user.

In Example 10, the subject matter of Examples 1-9 includes, determining that the goal has been reached; and automatically moving a predetermined amount of money from the second savings account to the first savings account.

In Example 11, the subject matter of Examples 1-10 includes, wherein linking the first savings account to the second savings account for the particular purchase includes linking the first and second savings accounts to a third savings account of a third user, the linking granting permission to the first, second, and third users to view the first, second, and third savings accounts.

In Example 12, the subject matter of Examples 1-11 includes, wherein the second user has a plurality of savings accounts each corresponding to a respective purchase, the plurality of savings accounts including the second savings account, and wherein linking the first savings account to the second savings account includes identifying that the particular purchase selected by the first user for the first savings account corresponds to a purchase of the second savings account.

In Example 13, the subject matter of Examples 1-12 includes, wherein the first and second users are connected on a social media network, and wherein linking the first savings account to the second savings account includes asking the first and second users to confirm sharing information about the first and second savings accounts based on the social media network connection.

Example 14 is at least one non-transitory machine-readable medium including instructions, which when executed by processing circuitry, causes the processing circuitry to perform operations to: create a first savings account for a first user for a particular purchase; link the first savings account to a second savings account of a second user for the particular purchase, the linking granting permission to the second user to view the first savings account; receive a goal for one of the first or second savings accounts; determine, using a trained model, a suggested action for the first user based on the particular purchase, the goal, and the first and second savings accounts; and output the suggested action for display.

In Example 15, the subject matter of Example 14 includes, wherein the suggested action includes a suggestion to the first user to contribute an amount of money to the first savings account that matches a deficit between the first savings account and the second savings account or a suggestion to the first user to request a donation from the second user based on a deficit between the first savings account and the second savings account.

In Example 16, the subject matter of Examples 14-15 includes, wherein the suggested action includes a suggestion to the first user to donate money to the second savings account based on a deficit between the first savings account and the second savings account or a suggestion to pool the first and second savings accounts based on a determination that the goal has been reached.

In Example 17, the subject matter of Examples 14-16 includes, wherein the instructions further cause the processing circuitry to perform operations to: determine that the goal has been reached; and automatically move a predetermined amount of money from the second savings account to the first savings account.

In Example 18, the subject matter of Examples 14-17 includes, wherein linking the first savings account to the second savings account for the particular purchase includes linking the first and second savings accounts to a third savings account of a third user, the linking granting permission to the first, second, and third users to view the first, second, and third savings accounts.

In Example 19, the subject matter of Examples 14-18 includes, wherein the second user has a plurality of savings accounts each corresponding to a respective purchase, the plurality of savings accounts including the second savings account, and wherein linking the first savings account to the second savings account includes identifying that the particular purchase selected by the first user for the first savings account corresponds to a purchase of the second savings account.

In Example 20, the subject matter of Examples 14-19 includes, wherein the first and second users are connected on a social media network, and wherein linking the first savings account to the second savings account includes asking the first and second users to confirm sharing information about the first and second savings accounts based on the social media network connection.

Example 21 is a method comprising: providing a user interface including a plurality of selectable interest indications; receiving a selection of one or more of the interest indications; generating a monetary account corresponding to the selection; receiving a ranking of the interest indications in the selection; predicting, using a model, a future amount of money in the monetary account; determining a feasible purchasing option for at least two of the interest indications in the selection based on the predicted future amount of money, the ranking, and price information for the at least two of the interest indications in the selection; and outputting the feasible purchasing option for display.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. A method comprising:
providing a user interface including a plurality of selectable interest indications;
receiving a selection of a selectable interest indication from the plurality of selectable interest indications, the selectable interest indication including a corresponding particular purchase;
creating, using a processor, a first savings account for a first user for the particular purchase;
linking, using the processor, the first savings account to a second savings account of a second user for the particular purchase, the linking granting first savings account viewing permission rights and at least one of deposit rights to the first savings account or withdrawal rights from the first savings account to the second user;
receiving a goal for one of the first or second savings accounts, the goal related to the selected interest indication;
determining, using a trained model, a suggested action for the first user based on the particular purchase, the goal, and the first and second savings accounts, the suggested action including a feasible purchasing option for the particular purchase, the feasible purchasing option using both the first and the second savings accounts, wherein the feasible purchasing option is determined based on a user timing preference; and
outputting the suggested action on the user interface.

2. The method of claim 1, wherein the suggested action includes a suggestion to the first user to contribute an amount of money to the first savings account that matches a deficit between the first savings account and the second savings account, and in response to outputting the suggested action, receiving a contribution from the first user in an amount that matches the deficit.

3. The method of claim 1, wherein the suggested action includes a suggestion to the first user to request a donation from the second user based on a deficit between the first savings account and the second savings account.

4. The method of claim 1, wherein the suggested action includes a suggestion to the first user to donate money to the second savings account based on a deficit between the first savings account and the second savings account.

5. The method of claim 1, wherein the suggested action includes a suggestion to pool the first and second savings accounts based on a determination that the goal has been reached.

6. The method of claim 1, wherein the suggested action includes a suggestion to make the particular purchase based on a determination that the goal has been reached.

7. The method of claim 1, wherein the goal is unique to the first savings account and a second goal corresponds to the second savings account, the goal and the second goal including at least one different value.

8. The method of claim 1, wherein the goal is a joint goal for the first and second savings accounts.

9. The method of claim 1, wherein the first savings account is a sub-account of a main savings account of the first user.

10. The method of claim 1, further comprising:
determining that the goal has been reached; and
automatically moving a predetermined amount of money from the second savings account to the first savings account.

11. The method of claim 1, wherein linking the first savings account to the second savings account for the particular purchase includes linking the first and second savings accounts to a third savings account of a third user, the linking granting permission to the first, second, and third users to view the first, second, and third savings accounts.

12. The method of claim 1, wherein the second user has a plurality of savings accounts each corresponding to a respective purchase, the plurality of savings accounts including the second savings account, and wherein linking the first savings account to the second savings account includes identifying that the particular purchase selected by the first user for the first savings account corresponds to a purchase of the second savings account.

13. The method of claim 1, wherein the first and second users are connected on a social media network, and wherein linking the first savings account to the second savings account includes asking the first and second users to confirm sharing information about the first and second savings accounts based on the social media network connection.

14. At least one non-transitory machine-readable medium including instructions, which when executed by processing circuitry, causes the processing circuitry to perform operations to:
provide a user interface including a plurality of selectable interest indications;
receive a selection of a selectable interest indication from the plurality of selectable interest indications, the selectable interest indication including a corresponding particular purchase;
create a first savings account for a first user for the particular purchase;
link the first savings account to a second savings account of a second user for the particular purchase, the linking granting first savings account viewing permission rights and at least one of deposit rights to the first savings account or withdrawal rights from the first savings account to the second user;
receive a goal for one of the first or second savings accounts, the goal related to the selected interest indication;
determine, using a trained model, a suggested action for the first user based on the particular purchase, the goal, and the first and second savings accounts, the suggested action including a feasible purchasing option for the particular purchase, the feasible purchasing option using both the first and the second savings accounts, wherein the feasible purchasing option is determined based on a user timing preference; and
output the suggested action on the user interface.

15. The at least one machine-readable medium of claim 14, wherein the suggested action includes a suggestion to the first user to contribute an amount of money to the first savings account that matches a deficit between the first savings account and the second savings account or a suggestion to the first user to request a donation from the second user based on a deficit between the first savings account and the second savings account.

16. The at least one machine-readable medium of claim 14, wherein the suggested action includes a suggestion to the first user to donate money to the second savings account based on a deficit between the first savings account and the second savings account or a suggestion to pool the first and second savings accounts based on a determination that the goal has been reached.

17. The at least one machine-readable medium of claim 14, wherein the instructions further cause the processing circuitry to perform operations to:
determine that the goal has been reached; and
automatically move a predetermined amount of money from the second savings account to the first savings account.

18. The at least one machine-readable medium of claim 14, wherein linking the first savings account to the second savings account for the particular purchase includes linking the first and second savings accounts to a third savings account of a third user, the linking granting viewing permission to the first, second, and third users to view the first, second, and third savings accounts.

19. The at least one machine-readable medium of claim 14, wherein the second user has a plurality of savings accounts each corresponding to a respective purchase, the plurality of savings accounts including the second savings account, and wherein linking the first savings account to the second savings account includes identifying that the particular purchase selected by the first user for the first savings account corresponds to a purchase of the second savings account.

20. The at least one machine-readable medium of claim 14, wherein the first and second users are connected on a social media network, and wherein linking the first savings account to the second savings account includes asking the first and second users to confirm sharing information about the first and second savings accounts based on the social media network connection.
